(19) United States
(12) Patent Application Publication
(10) Pub. No.: US 2016/0356061 A1
(43) Pub. Date: Dec. 8, 2016

(54) LOCKING BOLT HOUSING, STRIKER PLATE AND ANTI-PRY DEVICE FOR ROLL-UP DOORS OF GARAGES, SHEDS AND DELIVERY TRUCKS

(71) Applicant: Joseph B. Gledhill, Provo, UT (US)

(72) Inventor: Joseph B. Gledhill, Provo, UT (US)

(21) Appl. No.: 15/173,606

(22) Filed: Jun. 3, 2016

Related U.S. Application Data
(60) Provisional application No. 62/170,642, filed on Jun. 3, 2015.
(60) Provisional application No. 62/247,169, filed on Oct. 27, 2015.

(51) Int. Cl. E05B 65/00; E05B 67/38; E05B 15/02; E05B 15/16; E05B 17/20; E05B 67/36; E05B 65/08

(52) U.S. Cl. CPC E05B 65/0021; E05B 67/36; E05B 67/38; E05B 65/0864; E05B 15/1614; E05B 17/2084; E05B 15/0205

(57) ABSTRACT

A locking system for segmented, roll-up doors includes a lockable bolt slidable within a bolt housing, a shielded striker plate, and an anti-pry device, which prevents the roll-up door from being shifted sideways in order to disengage the bolt of the deadbolt lock from the striker plate. A first embodiment system employs a lockable bolt provided by a conventional deadbolt lock that installs within the bolt housing. The key of the deadbolt lock is rotated so that the bolt slides enters an aperture in the striker plate. The second embodiment has a lockable bolt that slides within the bolt housing, is preferably made of hardened steel, and has a hasp welded to one end thereof. The bolt housing incorporates a semi-cylindrical steel rampart on the exterior surface of the housing, which forms a receptacle for a hidden-shackle cylindrical lock that can lock to the hasp.

### FIELD OF THE INVENTION

The present invention relates, generally, to locks for roll-up doors and, more particularly, to a locking bolt housing, striker plate and anti-pry device for installation on roll-up doors used on garages, sheds and delivery trucks.

### BACKGROUND OF THE INVENTION

Our material possessions are typically protected by locks. Our vehicles, our houses and our garages are all protected by locks. For the most part, the ignition locks on our vehicles and the locks on the entrances to our homes are generally of high quality, and can be defeated only by those possessing special tools and skills. However, the locks on garage doors, which supposedly prevent access to our vehicles, tools, yard equipment and expensive toys, are typically padlocks, which can be defeated with relative ease. Often, all that is needed is one of the following items: a crow bar, a bolt cutter, a battery-powered grinder or a battery-powered hand-held cut-off saw. Once a burglar has invaded a garage, he is out of sight and well on his way to breaking into the home.

Many attempts have been made to provide a low-cost locking mechanism for garage doors that is resistant to burglars. Here are some examples of those attempts:

U.S. Pat. No. 3,996,774 to Walter E. Best (1976 Dec. 14) discloses a high security locking mechanism in which the lock and the hasp and keeper assembly interact to give high security. The lock encloses and closely embraces the eyes of the hasp and keeper and lies close against the pads of the hasp and keeper. Shroud plates overlying the pads closely surround the rear edge of the lock. The shrouds and plates of the hasp meet those of the keeper at a separation plane offset from that of the eyes and of the door and its jamb.

U.S. Pat. No. 4,754,626 to Myron Siegel (1988 Jul. 5) discloses a shackleless lock protector that is designed to be received over a padlock strap and staple combination used to lock a door. It consists of an elongated block or bar having an opening for receiving the padlock staple, and a larger opening in a face of the block receives a flat cylindrical lock member that also receives the padlock staple and locks the door by the employment of a key to advance the lock member bolt through the staple.

Though the two foregoing locking devices utilize a cylindrical lock, they can be pried open using a crow bar and, thus, are not adequate to provide a secure locking mechanism for a movable wall member to a fixed wall member.

Other locking devices used to lock a movable wall member to a fixed wall member involve a removable pin that is inserted into the hasp and must also enter a hole in the back plate of the hasp to create a locking action, then the cylinder lock is placed on top of the pin to lock the pin to a fixed staple.

U.S. Pat. No. 4,345,448 to Martin D. Solomon (1982 Aug. 24) discloses a locking assembly for normally separable apertured structures which protect business fronts against burglary. The locking assembly includes a sturdy, straight pin which penetrates all apertures, and is part of a sturdy bracket which overlies a fixed standard or post. This device is intended to be locked with a cylindrical lock.

U.S. Pat. No. 5,172,574 to Ralph J. Perfetto (1992 Dec. 22) discloses a locking system utilizing a padlock guard which is designed specifically for use with a cylindrical lock. The lock has a flat-faced cylindrical housing and an internal key cylinder-operable bolt which can be selectively protracted through and retracted from a hasp staple or the like inserted into a channel in the housing which intersects the path of movement of the bolt.

U.S. Pat. No. 5,469,722 (1995 Nov. 28) to Robert J. Ellefsen discloses a hasp and a round cylinder lock embedded in a protective indentation built into the hasp. The hasp is comprised of a steel reinforced plate having a truncated circular indentation on a front side thereof for encapsulating an outer diameter of the round cylinder lock. The truncated circular indentation has a hasp hole. A locking pin extends from the round cylinder lock into the hasp hole. A plate lug is supported on the steel reinforced plate and projects axially outwardly from the truncated circular indentation for internal telescoping engagement of the round cylinder lock. A sliding tubular lock shaft is located within the round cylinder lock, and the plate lug is extendible into the round cylinder lock for receipt of the sliding tubular lock shaft within the plate lug hole, thereby enabling the plate lug and the hasp to be secured in locked assembly with the round cylinder lock.

The prior art has put forth several designs for garage door deadbolts. Among them are the following:

U.S. Pat. No. 4,480,863 (1984 Dec. 6) to Michael Hormann describes a latch assembly for use in combination with slidable doors is disclosed. A rotatable disk is connected to the door so that the plane of the disk is perpendicular to the door and parallel to the direction of door movement. A lock bolt which projects from the door jam is adapted to engage a slot in the disk as the door closes, causing the disk to rotate. As the disk rotates, it slides with respect to a spring loaded latch bolt until the bolt slides through a second slot in the disk, when the door is fully closed.

U.S. Pat. No. 4,739,584 to Peter Zellman (1988 Apr. 26) describes an auxiliary or backup locking mechanism which is used primarily with garage doors of the swing-up type which are controlled by an automatic garage door opener. The backup mechanism causes the lower corners of the door to be secured when in the closed position and to be unlocked by the operation of the garage door opener when the door is to be opened.

U.S. Pat. No. 6,382,005 B1 to Bryan A. White and Clyde D. Herman (2002 May 7) describes a remote controllable dead bolt type of locking apparatus is to be retrofittedly mounted in conjunction with a conventional garage door which is to function to securely lock the garage door preventing unauthorized entry though the garage door. The locking apparatus uses an elongated draw bar assembly that connects between the right side door jamb and the left side door jamb which defines the transverse sides of the opening within which is mounted the garage door.

U.S. Patent Application Publication no. 2011/0203333 A1 (2011 Aug. 25), by Robert Jimenez, discloses a dead bolt locking assembly that is bolted to a sliding door, the assembly having a dead bolt that rotates freely about its axis to prevent it from being cut, and a dead bolt receiver that is bolted to the door frame.

### SUMMARY OF THE INVENTION

A primary objective of the present invention is to provide a locking device for segmented roll-up doors installed on parallel tracks that are used on garages, sheds, and delivery vans and trucks so that the locking device, itself, would not be the weak link in the protection of the contents of those enclosed spaces. Though it is well understood that any type of locking device can be defeated with the proper tools and a resolved determination, the objective is to discourage thieves from breaking in a protected space by forcing them to engage in far more destructive behavior that will generate much greater noise over a much longer period of time, which will greatly increase the odds of them discovered, caught and prosecuted.

The present invention provides a locking system that includes a lockable bolt slidable within a bolt housing, a shielded striker plate, and an anti-pry device, which prevents the roll-up door from being shifted sideways in order to disengage the bolt of the deadbolt lock from the striker plate. Two main embodiments of the locking system are provided. The locking bolt and the bolt housing are the two components that are differ between the two embodiment locking systems.

The first embodiment locking system employs a lockable bolt provided by a conventional dead bolt lock that installs within the bolt housing. In order to lock the door on which the locking system is installed, the key of the deadbolt lock is rotated so that the bolt slides toward the striker plate and enters a locking aperture within the striker plate. Deadbolt locks from Schlage, ASSA, Medico and other manufacturers may be used with the deadbolt housing of the present invention.

The second embodiment bolt housing employs a lockable bolt, which slides within the housing, is preferably made of hardened steel, and has a hasp welded to one end thereof. Over its range of travel, the opposite ends of the bolt both remain within apertures in the housing walls. The bolt housing incorporates a semi-cylindrical steel rampart on the exterior surface of the housing, which forms a receptacle for a hidden-shackle cylindrical lock and which has a wide cutout for the lock's key and a narrow cutout through which the hasp slides. In order to secure the door on which the second embodiment locking system is installed, the locking bolt is slid toward the striker plate so that the end most distant from the hasp exits the housing and enters a locking aperture within the striker plate. With the hasp of the locking bolt now centered within the lock receptacle, a cylindrical lock is placed within the receptacle and the lock cylinder rotated with a key to secure the cylindrical lock to the hasp, thereby securing the roll-up door.

The anti-pry device may be either a stand-alone assembly or it may be incorporated into the striker plate and bolt housing. The stand-alone assembly is installed on the side of the door opposite that where the locking bolt housing is installed, and includes a door-mountable component and a frame-mountable component. Together, the two components prevent the roll-up door from being shifted away from the striker plate so that the bolt becomes disengaged. For the other embodiment of the anti-pry device, the striker plate incorporates a channel that wraps around the projection on the locking bolt housing. The anti-pry device that is incorporated into the striker plate and bolt housing has an advantage in that the roll-up door requires no stiffener rib to prevent the door from being accordioned or bowed if it is pried away from the striker plate in order to disengage the locking bolt from the striker plate.

### BRIEF DESCRIPTION OF THE DRAWINGS

FIGS. 1 through 19 depict several variants of the first embodiment locking system, which employs a lockable bolt provided by a conventional dead bolt lock that installs within the bolt housing. FIGS. 20 through 28 depict several variants of the second embodiment locking system, which employs a lockable bolt that slides within the housing, has a hasp welded to one end thereof, and is securable with a hidden-shackle cylindrical lock.

FIG. 1 is a front elevational view of a first embodiment deadbolt lock housing and striker plate, with a deadbolt installed in the housing;

FIG. 2 is a top plan view of the first embodiment deadbolt lock housing and an installed deadbolt within a partial cutaway view of the door and doorjamb on which it is installed;

FIG. 3 is an isometric view of the first embodiment deadbolt lock housing without an installed deadbolt;

FIG. 4 is a rear elevational view of the first embodiment deadbolt lock housing with a deadbolt installed;

FIG. 5 is a bolt-side elevational view of the first embodiment deadbolt lock housing, with the deadbolt lock installed therein;

FIG. 6 is a front elevational view of a security strike plate;

FIG. 7 is front elevational view of a second embodiment deadbolt lock housing;

FIG. 8 is an isometric view of the second embodiment deadbolt lock housing;

FIG. 9 is an alternative isometric view of the second embodiment deadbolt lock housing;

FIG. 10 is a front elevational view of a third embodiment deadbolt lock housing;

FIG. 11 is a rear elevational view of the third embodiment deadbolt lock housing;

FIG. 12 is a top plan view of the third embodiment deadbolt lock housing;

FIG. 13 is a side elevational view of the third embodiment deadbolt lock housing;

FIG. 14 is a first component of an anti-pry device that mounts on an interior side edge of a roll-up door opposite the side on which the deadbolt lock housing is installed;

FIG. 15 is a second component of the anti-pry device that mounts on the door frame adjacent the first component when the roll-up door is in a down position;

FIG. 16 is an isometric view of an anti-pry fourth embodiment deadbolt lock housing;

FIG. 17 is a top plan view of the fourth embodiment deadbolt lock housing and an anti-pry striker plate;

FIG. 18 is rear elevational view of the fourth embodiment deadbolt lock housing;

FIG. 19 is a top plan view of the fourth embodiment deadbolt lock housing and an installed deadbolt within a partial cutaway view of the door and doorjamb on which it is installed;

FIG. 20 is an isometric view of a first embodiment locking bolt and housing assembly, with the locking bolt in an unlocked position;

FIG. 21 is an isometric view of the first embodiment locking bolt and housing assembly, with the locking bolt having been move to a locked position;

FIG. 22 is an isometric view of the first embodiment locking bolt and housing assembly, with the locking bolt in a locked position and a hidden-shackle lock having been installed within the lock receptacle and the lock shackle having been secured to the bolt hasp;

FIG. 23 is an isometric view of a second embodiment locking bolt and housing assembly fitted with a standard-height skid plate;

FIG. 24 is an isometric view of a third embodiment locking bolt and housing assembly fitted with a tall skid plate;

FIG. 25 is a bottom plan view of the second embodiment locking bolt and housing assembly, with the locking bolt in an unlocked position, and showing the door, the jamb, and track assemblies;

FIG. 26 is a bottom plan view of the second embodiment locking bolt and housing assembly, with the locking bolt in a locked position, and showing the door, the jamb and track assemblies;

FIG. 27 is a bottom plan view of the second embodiment locking bolt and housing assembly, with the locking bolt in a locked position, a hidden-shackle lock installed in the housing receptacle, and showing the door, jamb and track assemblies; and

FIG. 28 is a bottom plan view of the third embodiment locking bolt and housing assembly, with the locking bolt in a locked position, and showing the door, the jamb and track assemblies.

### PREFERRED EMBODIMENT OF THE INVENTION

The invention will now be described with reference to the attached drawing figures. It should be understood that the drawings are not necessarily drawn to scale, and are intended to be merely illustrative of the invention. It should be further understood that the idea behind the present invention is not to make a space protected by a parallel-track-mounted, segmented, roll-up door impenetrable by determined thieves and burglars, which of course is impossible, but rather to make it far more difficult to break into the protected space and require the use of noisy power tools to defeat the lock. Burglars greatly prefer to work in relative silence, as the generation of noise during their breaking and entering is likely to alert others to their crime, and greatly increases the probability that they will be caught and punished.

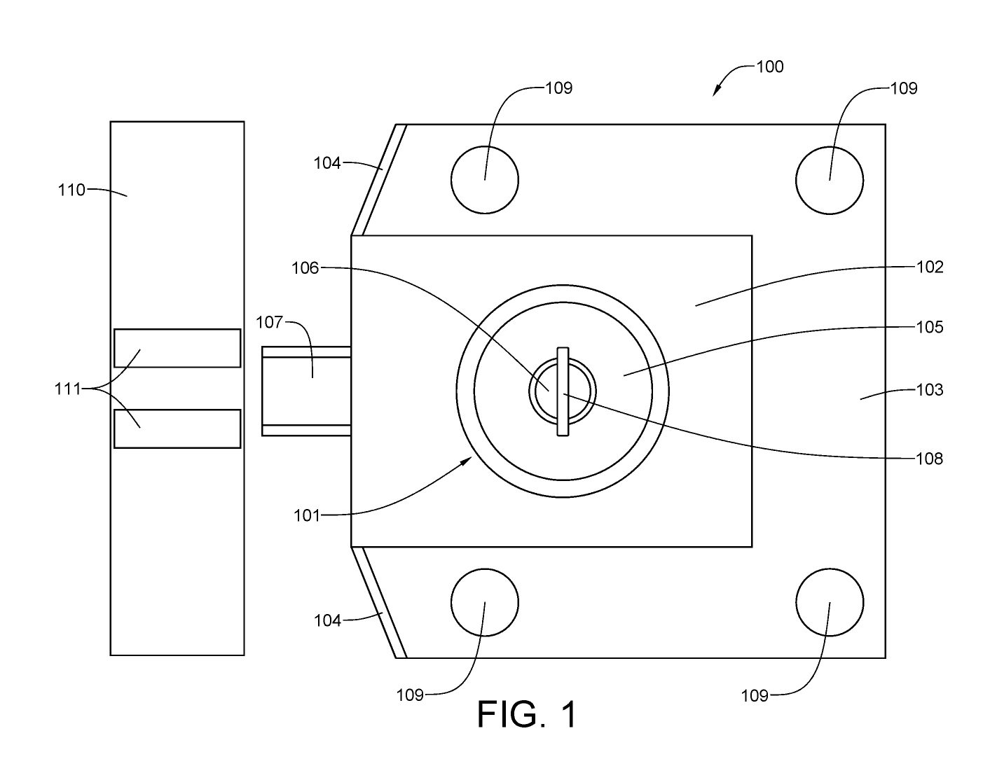

Referring now to FIG. 1, a deadbolt lock 101, of the type that is used on residential and commercial entry doors, has been installed in a first embodiment deadbolt lock housing 100. The housing 100 includes a box 102. a mounting plate 103, and angled guide tabs 104, all of which are welded together as a single unit, and are all made of heavy gauge laminar steel. The deadbolt lock 101 has a front lock body 105, a lock cylinder 106, and a deadbolt 107, which is seen protruding from the left side of the box 102. A key 108 is shown inserted into the deadbolt lock 101. Four carriage bolts 109, of which only the heads are visible, are used to anchor the mounting plate 103 to a roll-up door. Also shown is a heavy gauge steel security strike plate 110. The striker plate 110, which is made from 90-degree stock is equipped with a pair of tungsten carbide blocks 111, which have been brazed to the strike plate 110. The tungsten carbide blocks 111 make it much more difficult to cut through the shielding plate of the strike plate 108 in order to cut the bolt 105. Rather than using a saw with a carbon steel blade, a burglar would need to use a cut-off saw equipped with a diamond edged blade. Few burglars are equipped with such sophisticated, noisy tools. The angled guide tabs 104 prevent the box 102 from snagging the strike plate 110 when the door, on which the deadbolt lock housing 100 is mounted, is rolled up and down.

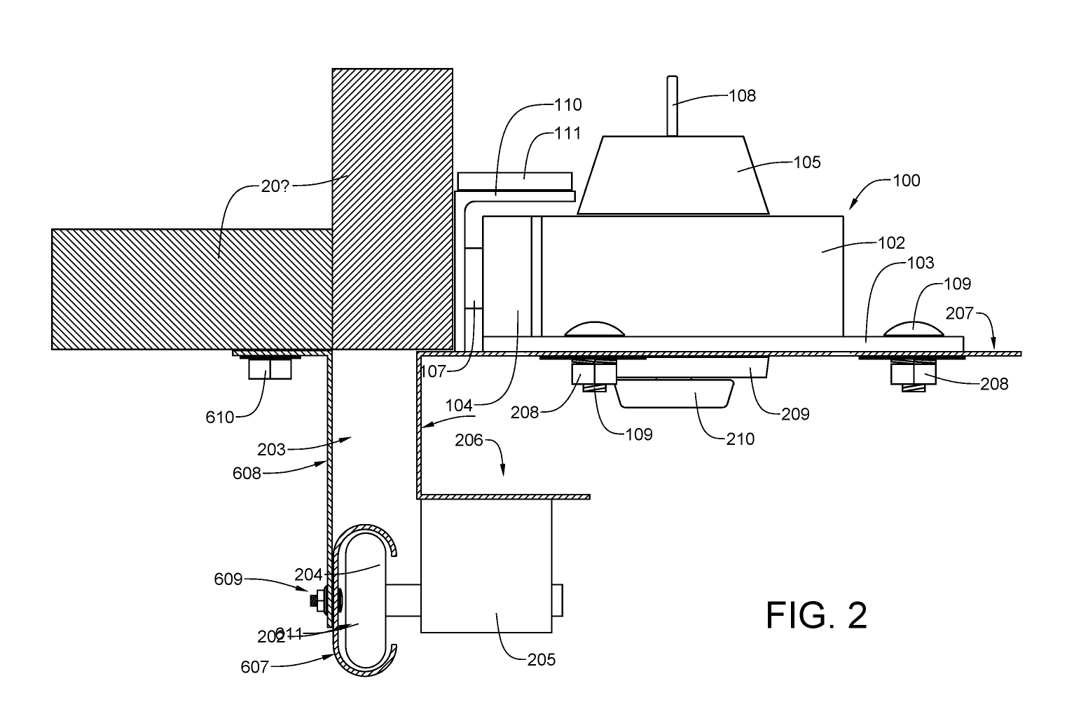

Referring now to FIG. 2, the deadbolt lock housing 100 is shown installed on a segmented, roll-up door that is installed on parallel tracks. In this top view, the door jam 201 is shown in cross-sectional format. The security strike plate 110 is secured to the door jam assembly 201. A door guide track 202 is also secured to the wall and door jam assembly 201 with a mounting bracket 203. The opposite and parallel track is not shown. A guide roller 204, that is attached to a roller assembly 205, rides in the door guide track 202. The roller assembly 205 is secured to a door stiffener rib 206, which is an integral part of the roll-up door 207. The nuts 208, which together with the carriage bolts 109, are used to secure mounting plate 103 to the roll-up door 207, are visible in this view. Also visible is the deadbolt lock backing plate 209, which in combination with a pair of lock-securing bolts (not shown in this view), secures the deadbolt lock body within the deadbolt lock housing 100, as is the thumb turn 210 that locks and unlocks deadbolt lock 101 from within the protected space (i.e., garage or cargo box). All other numbered elements of this drawing were heretofore identified in the description of FIG. 1.

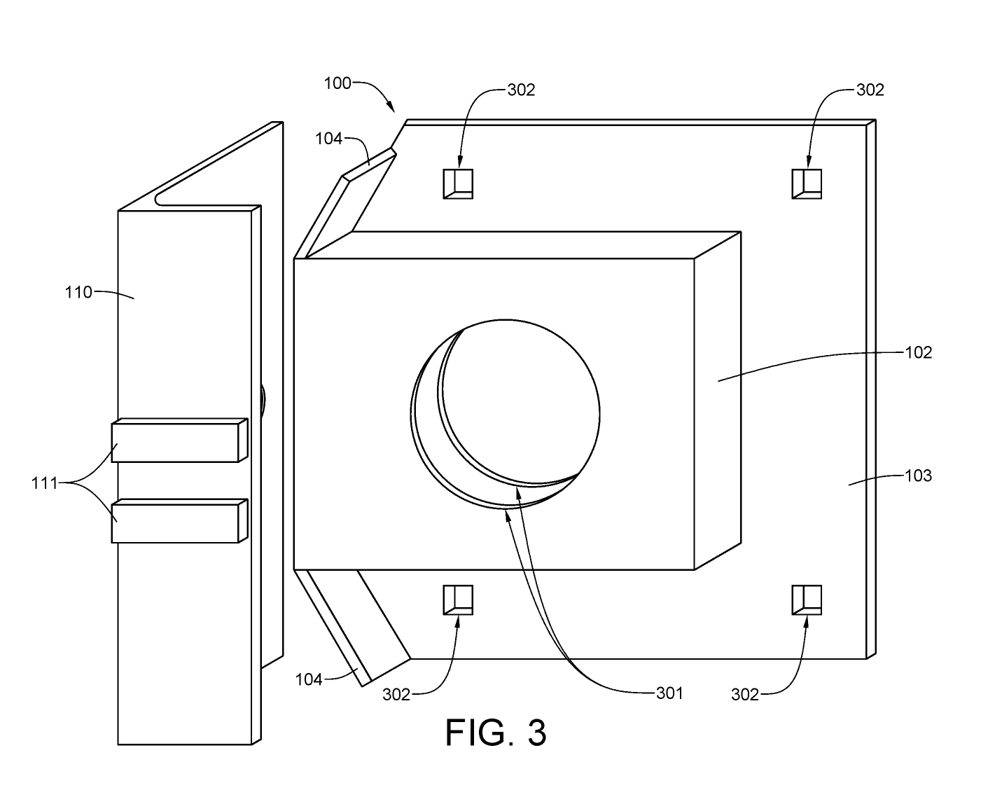

Referring now to FIG. 3, the deadbolt lock housing 100 and the security striker plate 110 are shown without the deadbolt lock 101 installed in the housing 100. The circular apertures 301 on both sides of the deadbolt lock housing, within which the deadbolt lock 101 is installed are visible in this view, as are the square apertures 302, which receive the housing-securing carriage bolts 109.

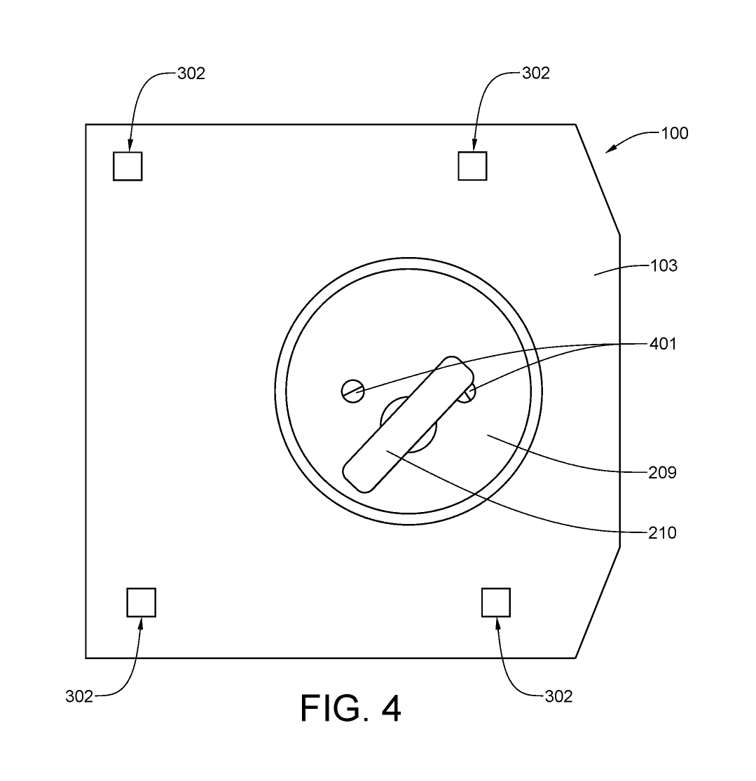

Referring now to FIG. 4, we are looking at the rear of the deadbolt lock housing 100, with the deadbolt lock 101 installed therein. In this view, the only component of the deadbolt lock housing 100 that is visible is the mounting plate 103. The deadbolt lock backing plate 209 is visible from the rear, as are the lock-securing bolts 401 that secure the backing plate 209 to the main body 105.

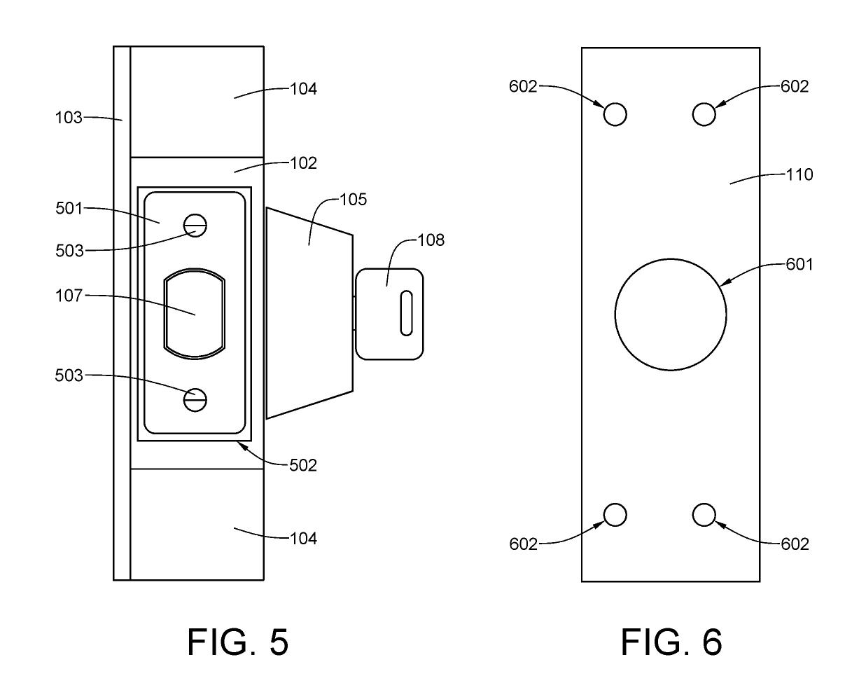

Referring now to FIG. 5, this bolt-side view of the first embodiment deadbolt lock housing 100, shows a deadbolt faceplate, or trim, 501 installed in a faceplate recess 502, and secured therein with faceplate securing screws 503. The deadbolt 107 can be seen centered in the faceplate 501.

Referring now to FIG. 6, the strike plate 110 is seen from the side which abuts against the door jam. Visible in this view is the single central deadbolt receiving aperture 601 and four smaller additional strike plate securing screw apertures 602.

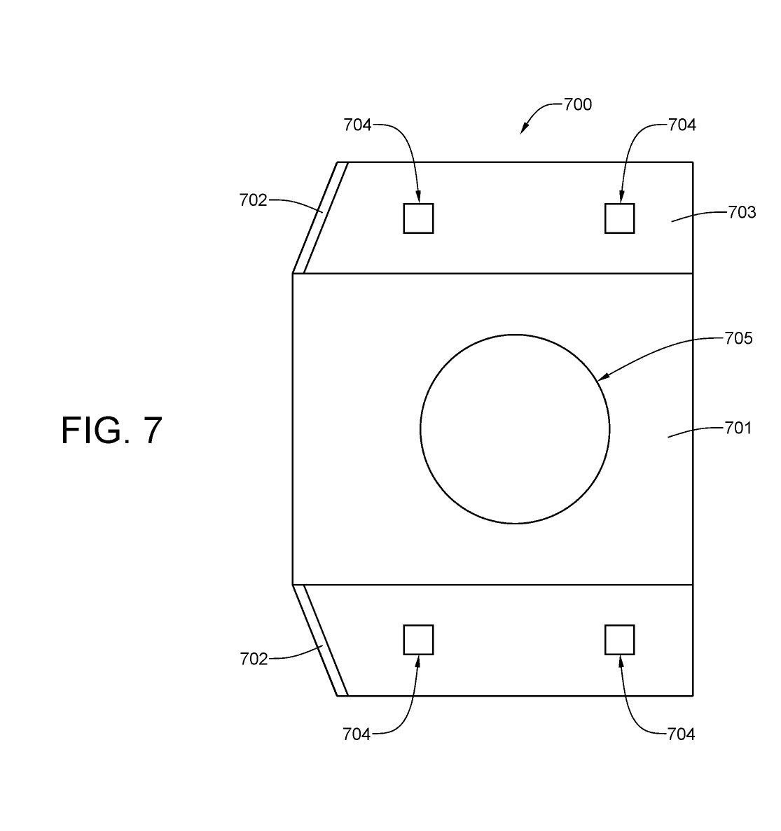

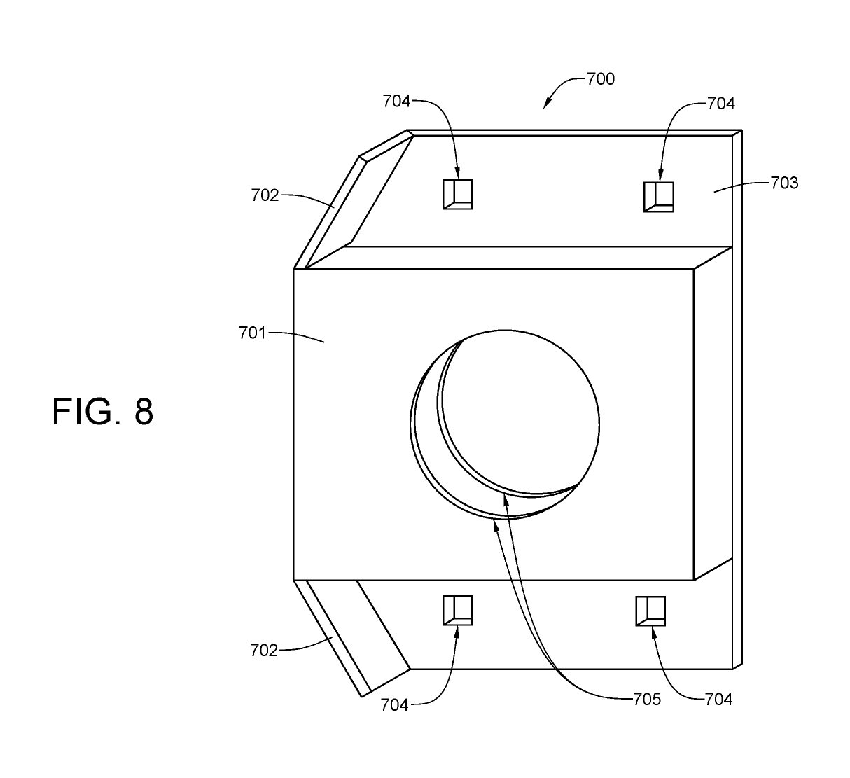

Referring now to FIGS. 7 and 8, a second embodiment deadbolt lock housing 700 is very similar to that of the first embodiment 100. The box 701 and the angled guide tabs 702 are identical. However, the mounting plate 703 is narrower, as is the pattern of square apertures 704, which receive the carriage bolts that are used to secure the deadbolt lock housing 700 to a roll-up door.

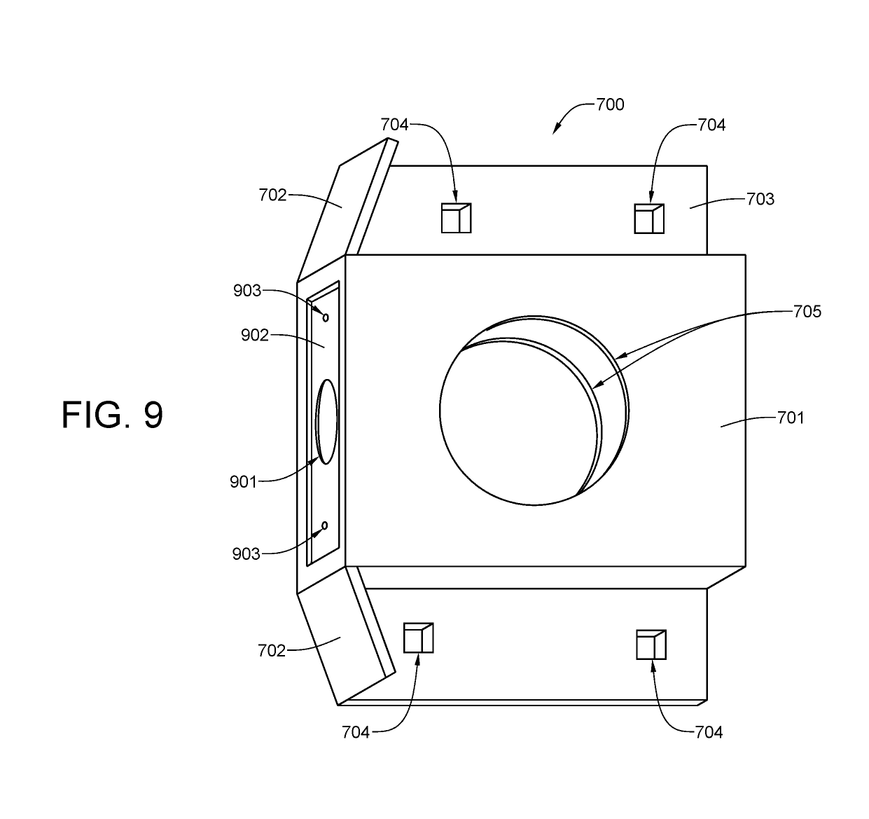

Referring now to another view of the second embodiment deadbolt lock housing 700 in FIG. 9, both deadbolt lock installation apertures 705 are visible, as is the deadbolt aperture 901 in the box 701, the faceplate trim recess 902, and the screw holes 903 used to secure the faceplate trim (not shown) within the faceplate recess 902.

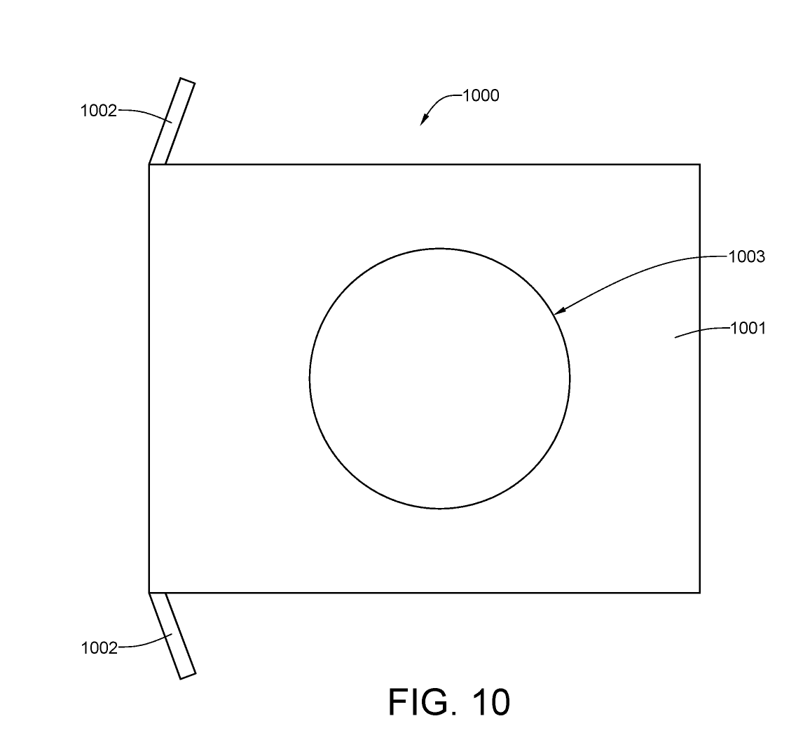

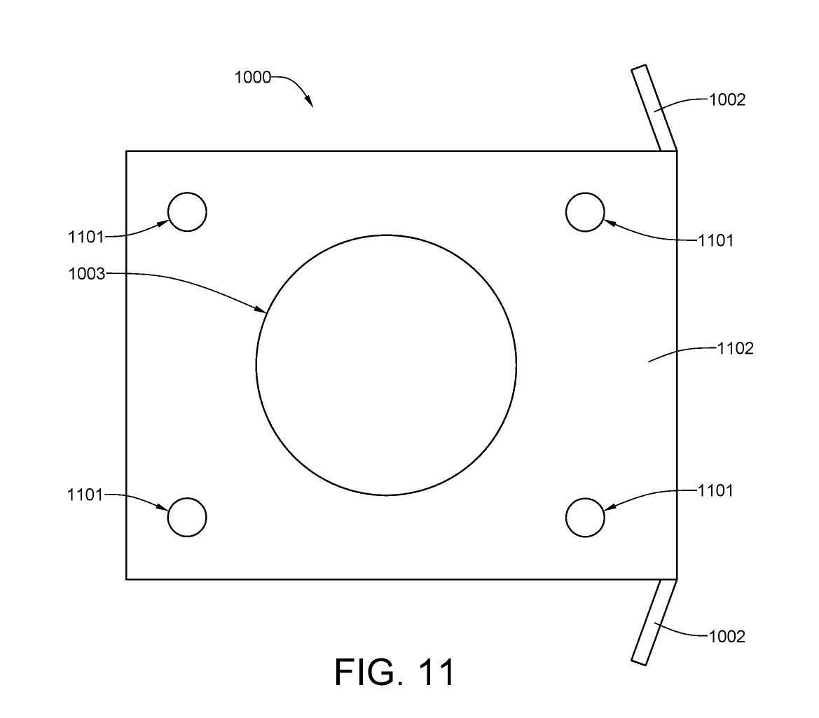

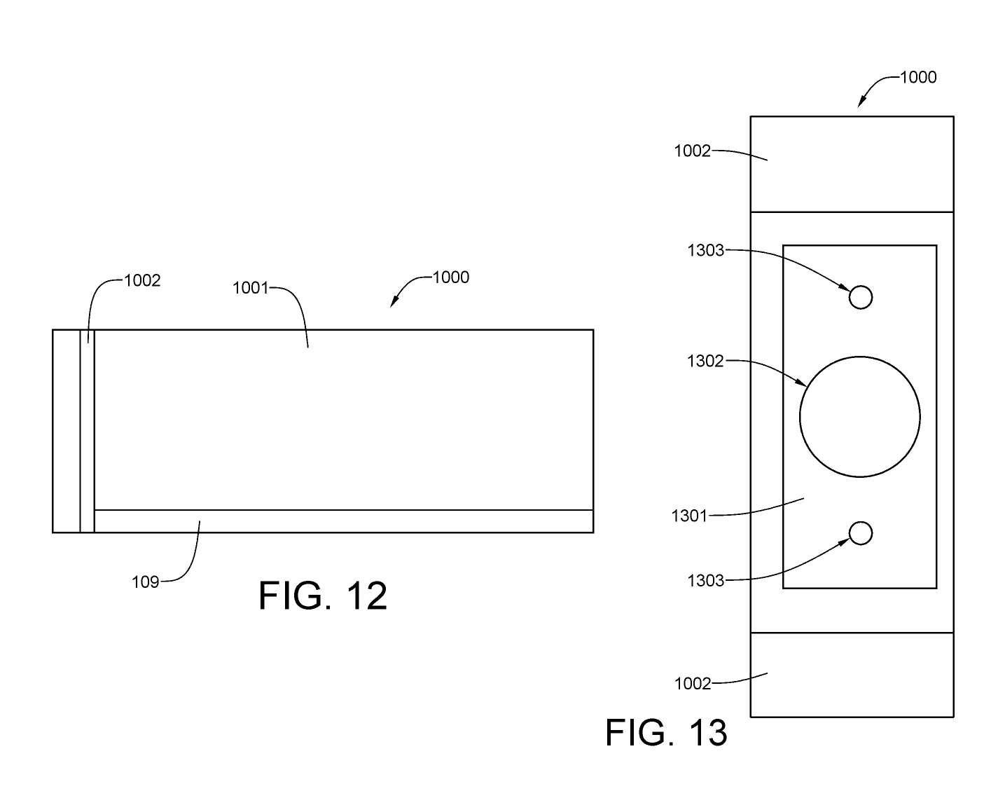

Referring now to FIG. 10 through 13, a third embodiment deadbolt lock has a box 1001 and angled guide tabs 1002 similar to those of the first and second embodiment deadbolt lock housings 100 and 700, respectively. However, the mounting plate 703 is coextensive with the box 1001. Given that there is no mounting flange partially surrounding the box 1001, mounting bolts must be screwed into threaded apertures 1101 at the rear panel 1102 of the box (see FIG. 11).

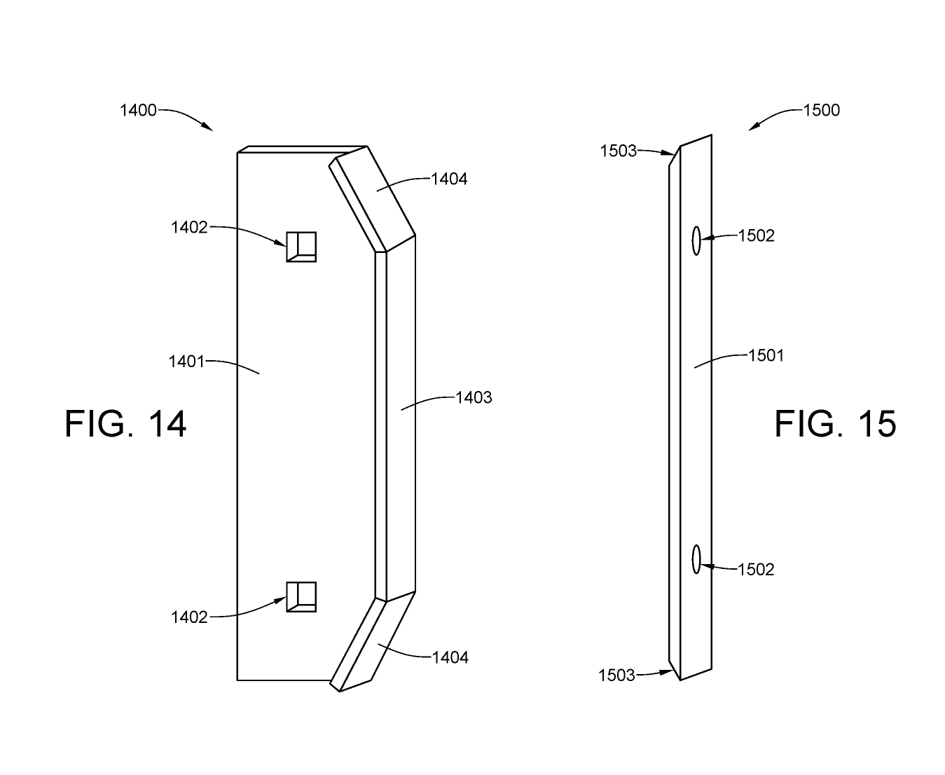

Referring now to FIGS. 14 and 15, an anti-pry device comprises two components: a first component 1400 (see FIG. 14) that mounts on the exterior surface of a roll-up door, adjacent a side edge that is opposite the side on which the deadbolt lock housing is installed; and a second component 1500 that mounts on the door frame opposite and adjacent the first component when the roll-up door is in a down position. When the roll-up door is in a fully-down position, there is preferably no more than about 0.25 centimeter between the first and second components 1400 and 1500, respectively. The anti-pry device, in combination with the deadbolt lock housing and security strike plate installed on the opposite side of the roll-up door, prevent the roll-up door from being shifted in either direction. Thus, the burglar cannot shift the door in a direction that will bend the guide track and cause the deadbolt to disengage from the strike plate. Instead, he will be forced to destroy the roll-up door in order to gain access to the protected space (i.e., garage or cargo box), which will likely involve the expenditure of a considerable amount of time and generate a lot of noise—two things that burglars prefer to scrupulously avoid. The first anti-pry component 1400 has a planar, laminar mounting portion 1401 having a pair of square apertures 1402 for receiving two securing carriage bolts. The planar laminar mounting 1401 portion is mounted on the front side of the roll-up door. Nuts (not shown) secure the first anti-pry component 1400 to the door from behind so that they are accessible only within the garage or cargo box. A blocking portion 1403 orthogonal to the mounting portion 1401 and unitary therewith abuts up against the second anti-pry component 1500 when the roll-up door is closed. Angled guide tabs 1404 prevent the first anti-pry component from hanging up on the second component when the roll-up door is closed. The second anti-pry component 1500 is a planar laminar strip 1501 having a pair of mounting apertures 1502 that enable the second anti-pry component 1500 to be securely fastened with screws to the door frame. Beveled ends 1503 also eliminate the possibility of a hang-up between the first and second anti-pry components.

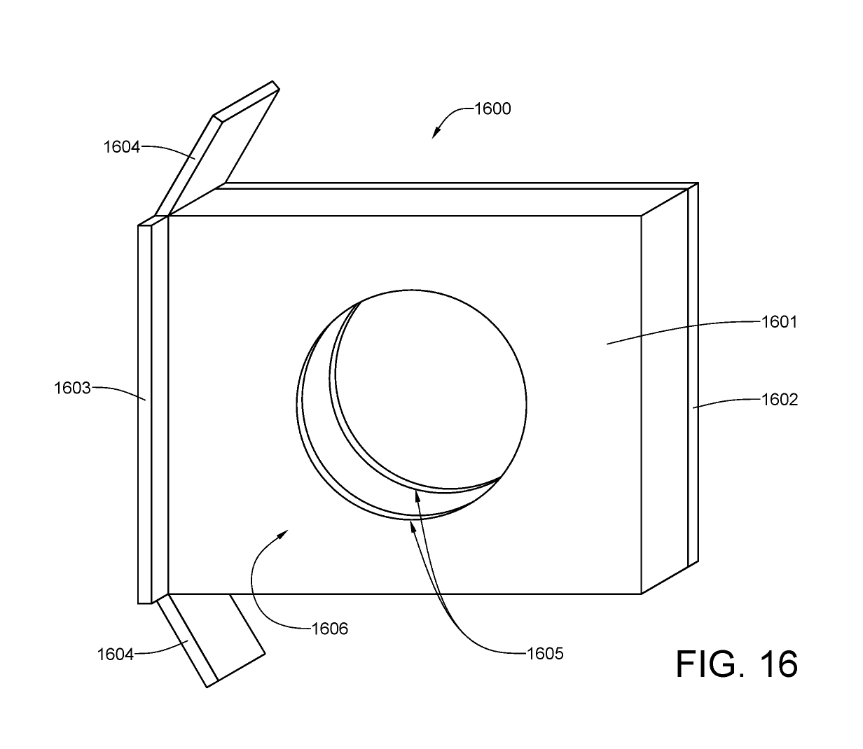

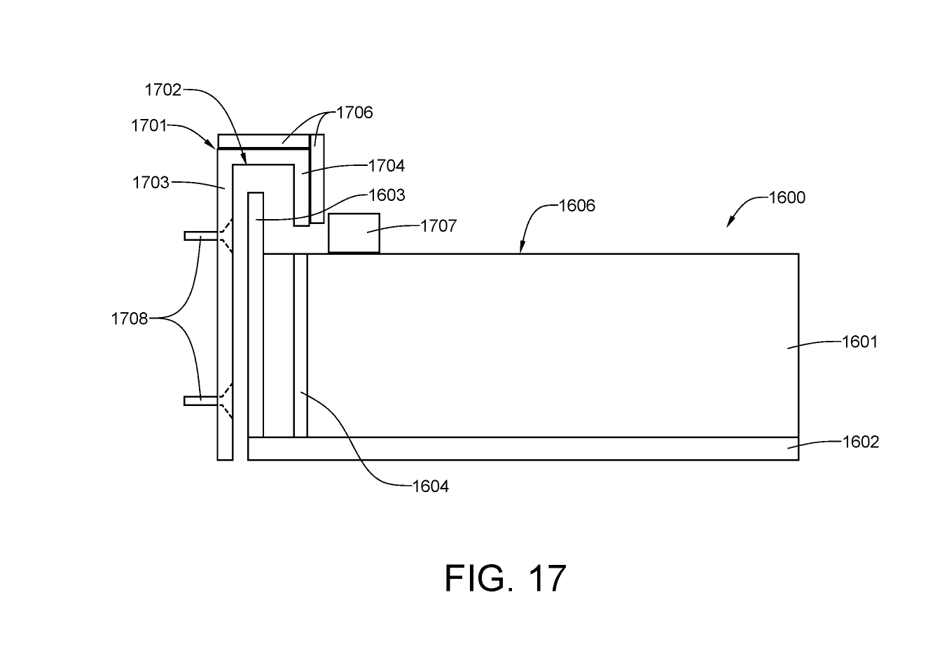

Referring now to FIG. 16, an anti-pry fourth embodiment deadbolt lock housing 1600 is similar to the third embodiment deadbolt lock housing 1000 of FIGS. 10 through 13. The housing 1600 has a box 1601, a rear panel 1602, deadbolt lock installation apertures 1605, and angled guide tabs 1604. However, the primary difference between the third and fourth embodiments is the addition of a vertically-oriented anti-pry projection strip 1603 on the jamb-adjacent edge of the box 1601. The projection strip 1603, which is perpendicular to the mounting plate 1602, extends outwardly from the face 1606 of the box about 1 to 1.5 cm. As will be seen in FIG. 17, this projection trip is trapped within a channel in the security strike plate when the roll-up door is in a fully down position.

Referring now to the top view of FIG. 17, the security strike plate assembly 1701 has a channel 1702 formed the strike plate portion 1703 of the assembly 1701 and a right-angle portion 1704. The projection strip 1603 is trapped within the channel 1702 when the roll-up door is in a fully down position. A pair of tungsten carbide blocks 1706 brazed to the right-angle portion 1704 and a single tungsten carbide block 1707 brazed to the face 1606 of the box 1601 hamper removal, by cutting, of the right-angle portion 1704 of the strike plate assembly 1701 and the anti-pry projection strip 1603 by burglars. Screws 1708 used to anchor the strike plate assembly 1701 to the door jam (not shown) are visible in this view, as are the angled guide tabs 1604.

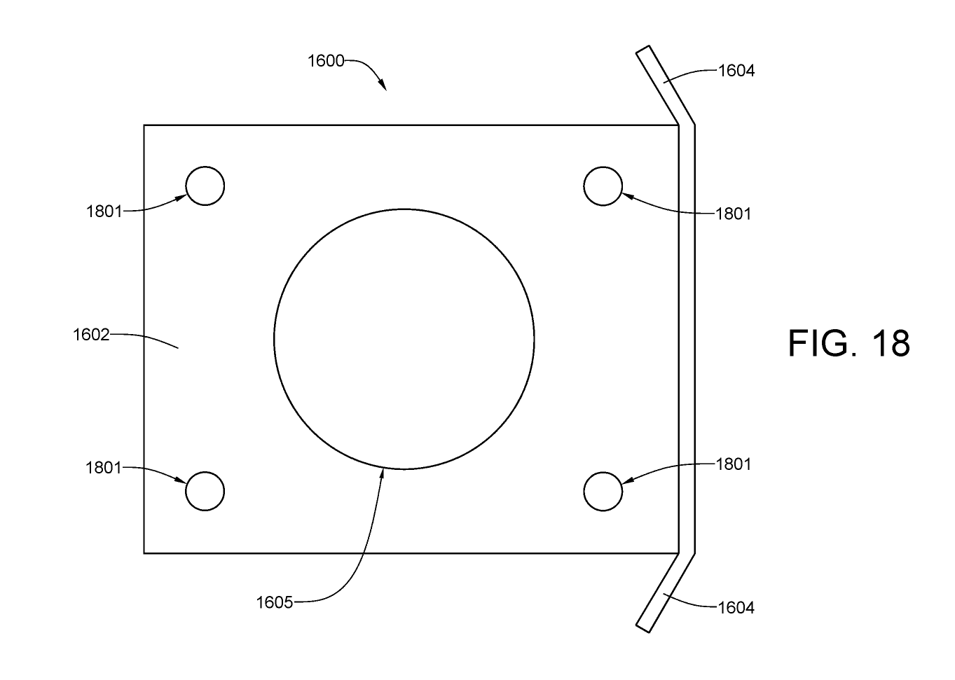

Referring now to the rear view of FIG. 18, the rear panel 1602 of the box 1601, which functions as a mounting plate, has four internally-threaded apertures 1801 for receiving the threaded shanks of bolts which secure the fourth embodiment deadbolt lock housing 1601 to the roll up door.

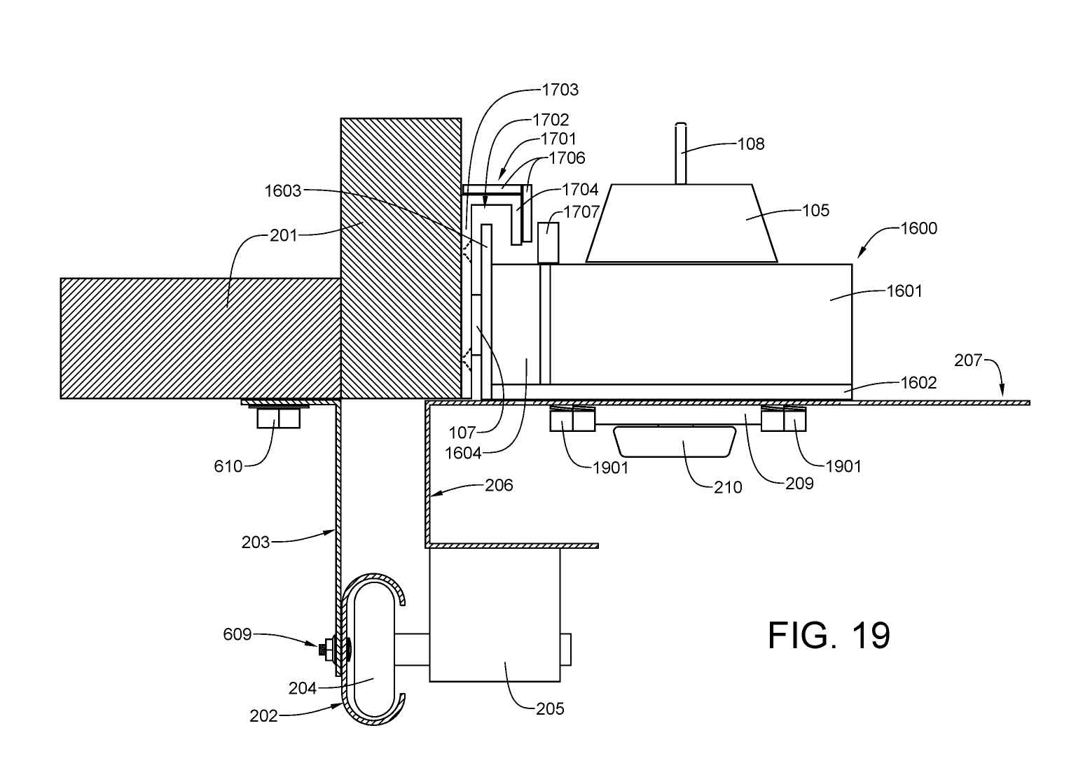

Referring now to the top of FIG. 19, a deadbolt lock 101, of which the main body 105, the retractable deadbolt 107, the backing plate 209, and a thumb turn 210 are visible in this view, has been installed within the fourth embodiment deadbolt lock housing 1600, and the entire assembly has been secured to a roll-up door 207 with securing bolts 1901 (only two of which are visible in this drawing). The security anti-pry striker plate 1701 has been installed on the door jam assembly 201. This view illustrates how the anti-pry projection strip 1603, trapped within the channel 1702 of the security anti-pry strike plate 1701, prevents the door from being pried more than a fraction of a centimeter to the right, thereby preventing a burglar from bending the track 202 and mounting bracket 203, disengaging the deadbolt 107 from the strike plate 1701, and rolling up the door 207 to gain entry to the protected space behind the door 207.

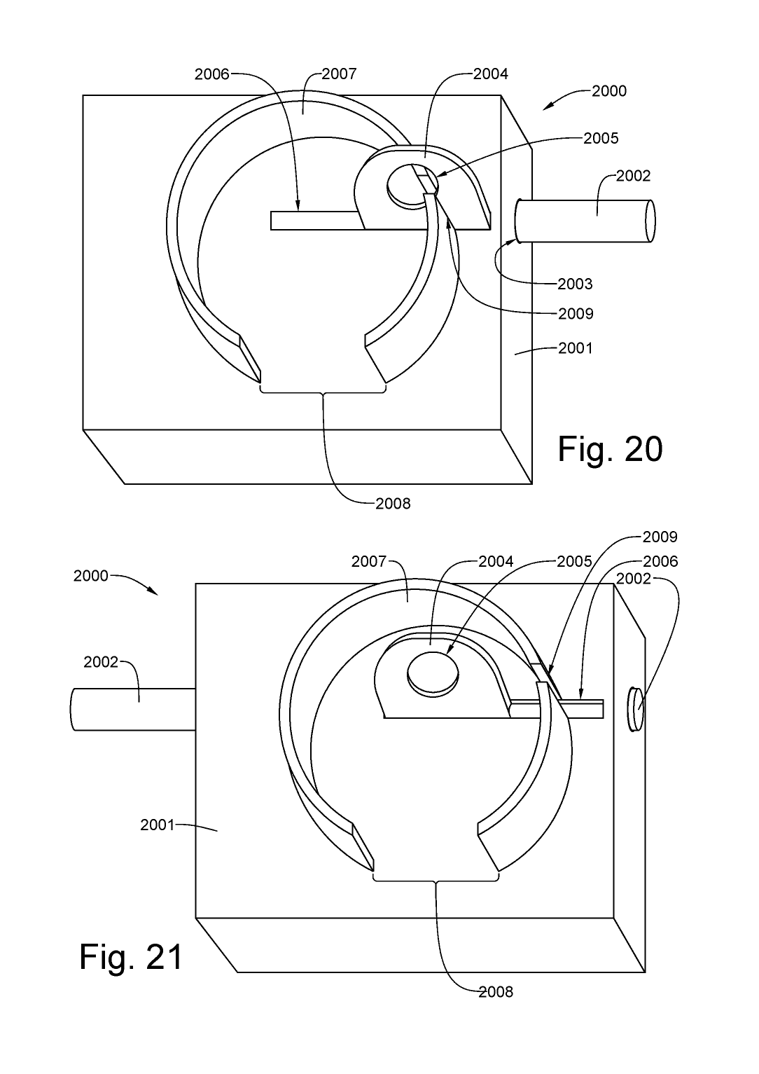

Referring now to FIG. 20, a first embodiment of the new locking bolt and housing 2000, that is securable with a hidden-shackle lock, has a steel rectangular housing 2001, a hardened steel bolt 2002 slidable within bolt apertures 2003 in the side walls of housing 2001, a hasp 2004 with a locking aperture 2005 that is welded to the bolt 2002 and that rides within a slot 2006 in the housing 2001, and a semi-cylindrical steel rampart 2007 that is welded to the housing 2001, and has a cutout 2008 for the key of the hidden-shackle lock and a notch 2009 through which the hasp 2004 can slide. For increased security, the housing 2001 and the rampart 2007 can be case hardened to make it more difficult to cut. The housing 2001 can be fabricated in a variety of ways. One way, as shown in this disclosure, is to assemble it from steel plates that are welded together and installing the bolt during the assembly process. Another is to CNC machine an open box, along with the required two apertures on opposite walls of the box, punch out or CNC machine a cover, install a pre-fabricated bolt and hasp assembly 2002/2004 within the apertures 2003 of the open box, and then weld the cover onto the box. The rampart 2007 and notch 2009 can be CNC machined as part of the open box or as part of the cover to be welded onto the box. Alternatively, it can be formed from a separate piece of steel and welded to either the box or cover, depending on the location of the notch 2009. In FIG. 20, the bolt 2002 and the hasp 2004 are shown in an open position.

Referring now to FIG. 21, the new locking bolt and housing 2000 of FIG. 20 is shown, with the locking bolt 2002 and hasp 2004 moved to a locked position. When the hasp 2004 is in this position, a hidden shackle lock can be secured to the hasp 2004, thereby securing the bolt 2002 and the hasp 2004 in the locked position. It w ill be noted that the length of the slot 2006 limits the travel of the hasp 2004, as well as the bolt 2002, to which it is welded, so that bolt ends of the bolt 2002 are always suspended between the opposing bolt apertures 2003 in the housing 2001.

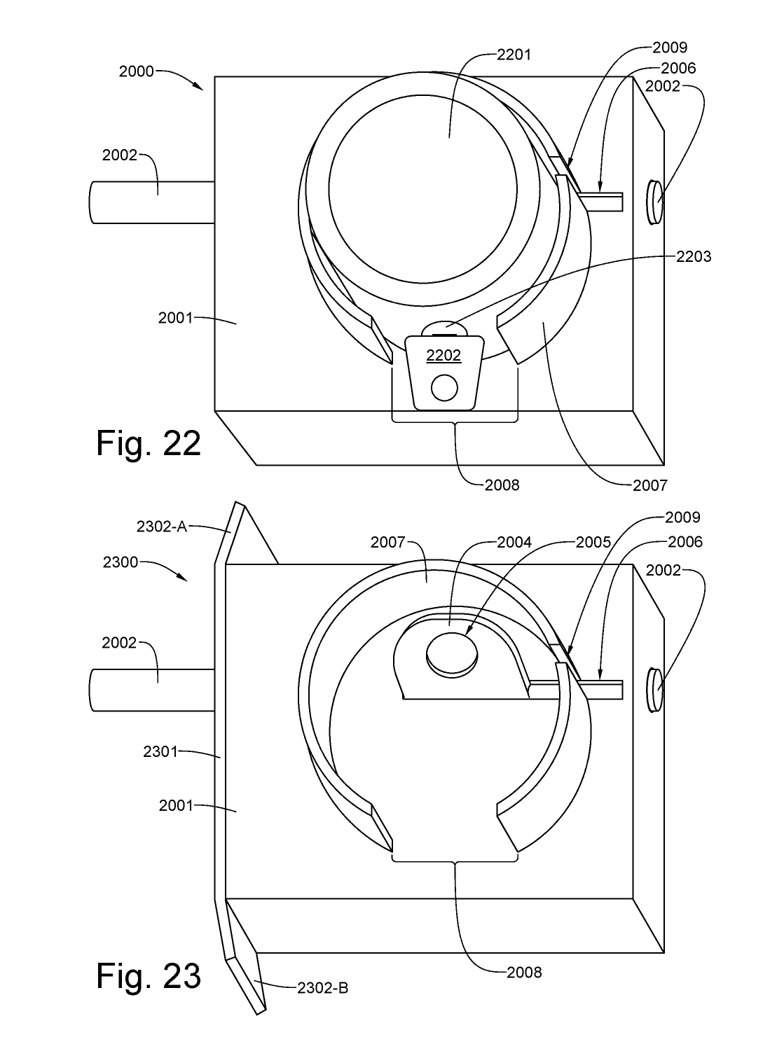

Referring now to FIG. 22, the new locking bolt and housing 2000, in the locked configuration shown in FIG. 21, has been secured with a hidden shackle lock 2201 from a first lock manufacturer. The key 2202 is inserted within the lock tumbler 2203 of the hidden shackle lock 2201. The hidden cylindrical shackle of the lock 2201 has engaged the aperture 2005 of the hasp 2004, thereby preventing the bolt 2002 from being moved from the locked position shown in FIG. 21.

Referring now to FIG. 23, for a second embodiment locking bolt and housing assembly 2300, a standard height skid plate 2301 having tapered ends 2302-A and 2302-B has been incorporated into the housing 2001. The skid plate 2301 prevents the housing 2001 from hanging up on an edge of the immovable striker plate as the door, on which the housing 2001 is mounted, is rolled up or down.

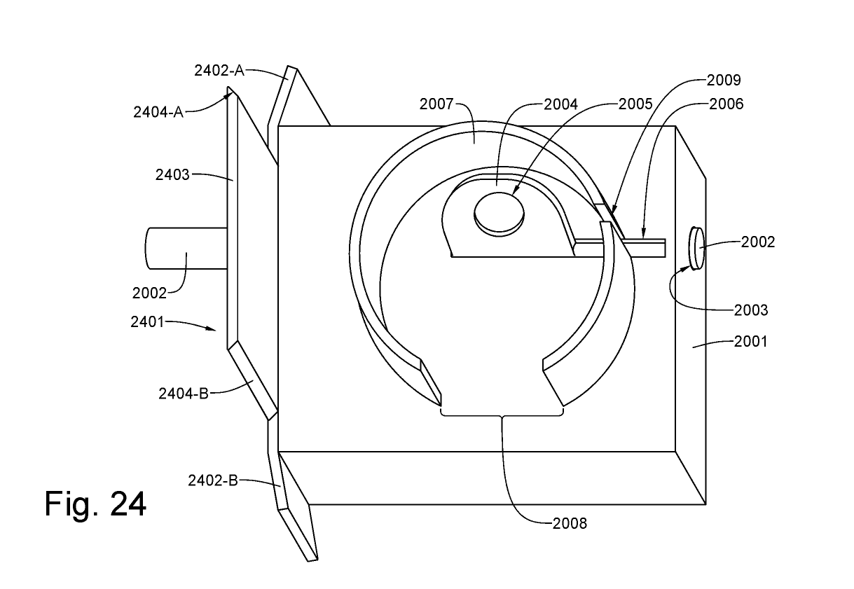

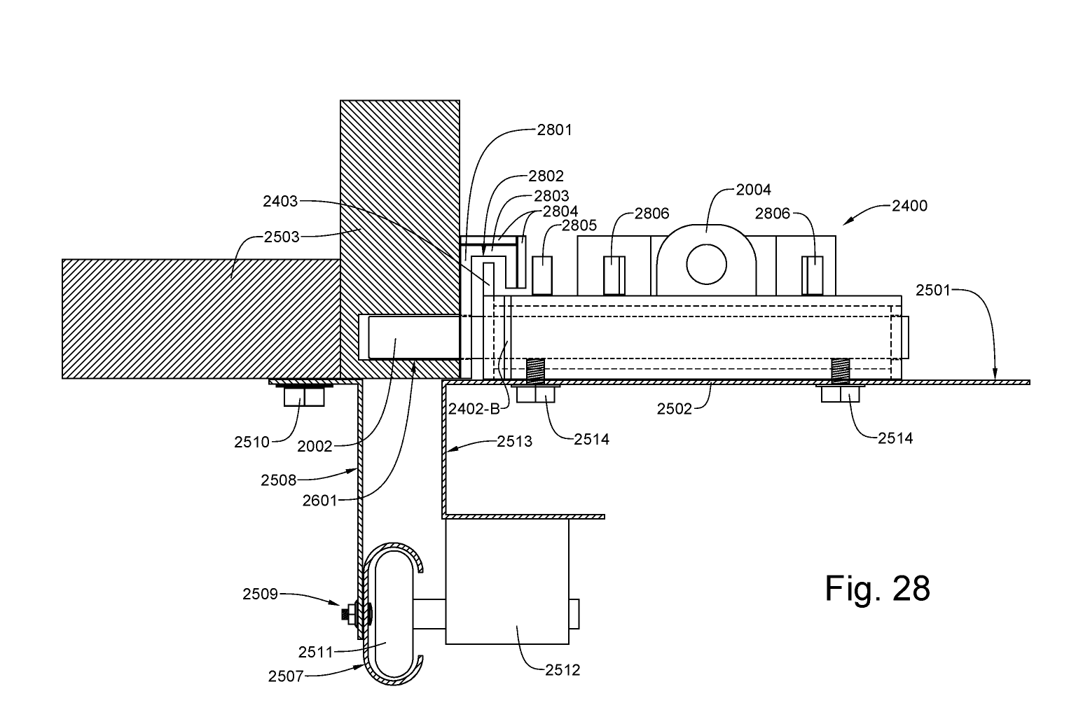

Referring now to FIG. 24, for a third embodiment locking bolt and housing assembly 2400, an enhanced skid plate 2401 has been incorporated into the housing 2001. The enhanced skid plate has tapered ends 2402-A and 2402-B, as w ell as an anti-pry projection 2403. The anti-pry projection 2403 has tapered edges 2404-A and 2404-B, which minimize the likelihood that the anti-pry projection 2403 will hang up on the U-shaped channel 2802 of the enhanced security plate 2801 (see FIG. 28). Like the skid plate 2301 of the second embodiment locking bolt and housing assembly 2300, the tapered ends 2402-A and 2402-B on the skid plate 2401 prevent the housing 2001 from hanging up on an edge of the immovable striker plate as the door, on which the housing 2001 is mounted, is rolled up or down.

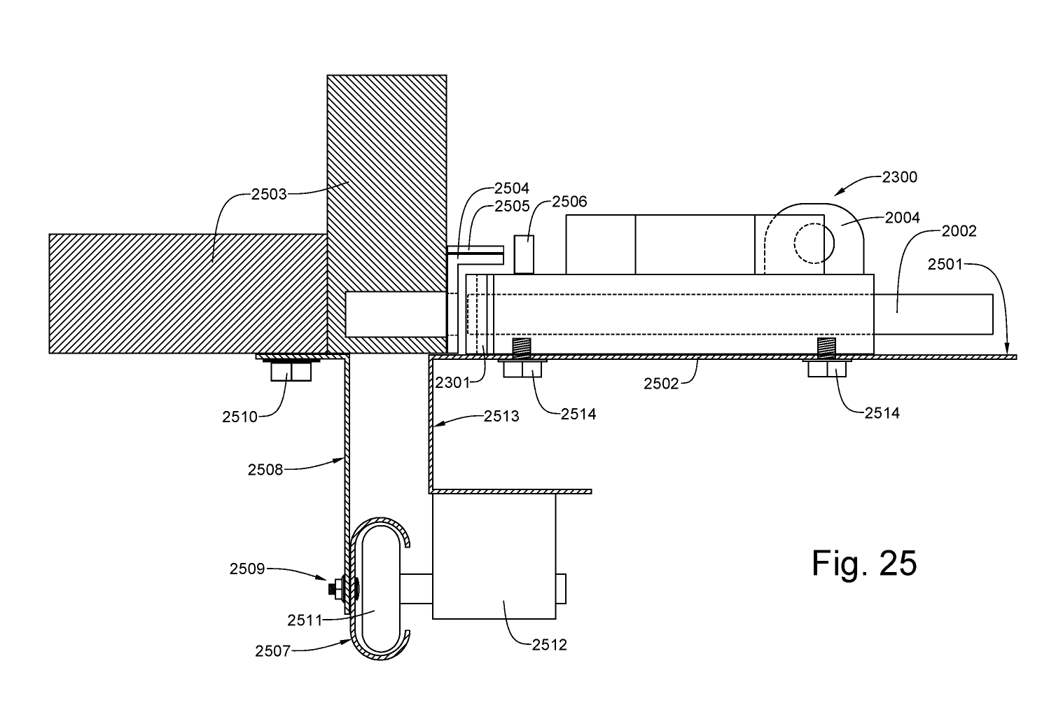

Referring now to FIG. 25, the second embodiment locking bolt and housing assembly 2300 has been mounted on the exterior surface 2501 of a roll-up door 2502 of the type used on garages, sheds and commercial delivery trucks. It will be noted that the bolt 2002 is in an unlocked position so that the roll-up door 2502 m ay be opened and closed. In this bottom view, the wall and door jam assembly 2503 is shown in cross-sectional format. A security strike plate 2504 of L-shaped cross section is secured to the wall and door jam assembly 2503. An optional silicon or tungsten carbide block 2505, brazed to the foot of the L-shaped security strike plate 2504 and an additional single silicon or tungsten carbide block 2506, brazed to the face of the housing 2001, make it difficult for a burglar to cut or grind off the foot of the security strike plate 2504 and, thereby gain access to the bolt 2002. A door guide track 2507 and a mounting bracket are held together with threaded fasteners 2509 (i.e., a screw and a nut). The mounting bracket is secured to the wall and door jam assembly 2503 with bolts 2510 (only one is shown in this view). A guide roller 2511, that is attached to a roller assembly 2512, rides in the door guide track 2507. The roller assembly 2512 is secured to a door stiffener rib 2513, which is an integral part of the roll-up door 2502. Multiple bolts 2514 are used to secure the locking bolt and housing 2000 to the roll-up door 2502.

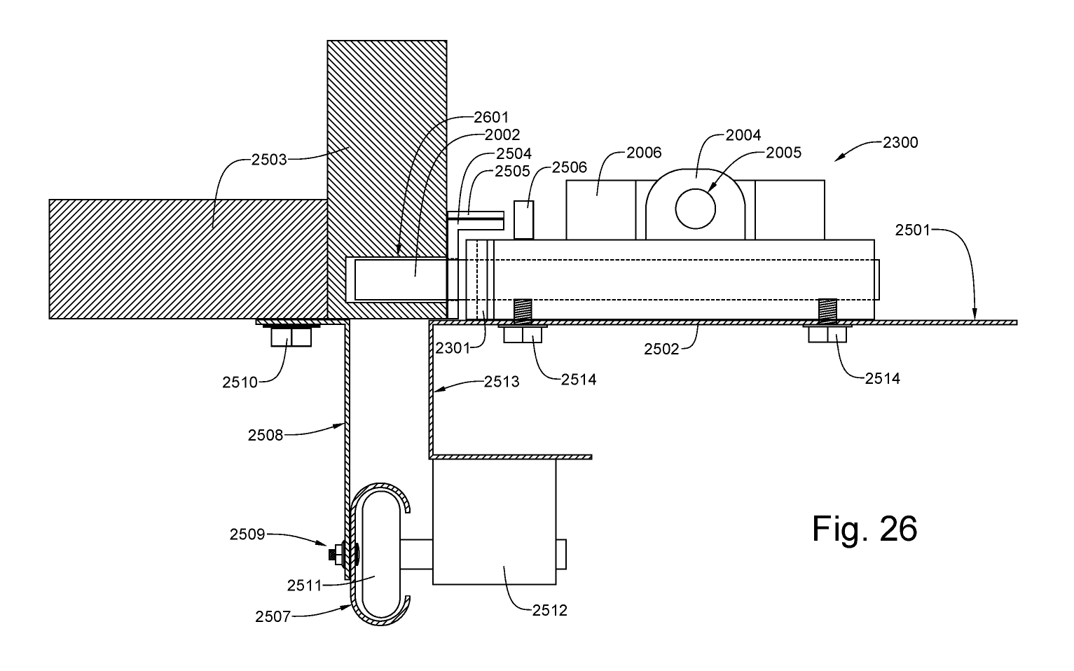

Referring now to FIG. 26, the second locking bolt and housing assembly 2300 of FIG. 25 is shown with the bolt 2002 in a locked position within a locking aperture 2601 in the wall and door jam assembly 2503. It will be noted that the hasp 2004 is centered within the semi-cylindrical rampart 2007.

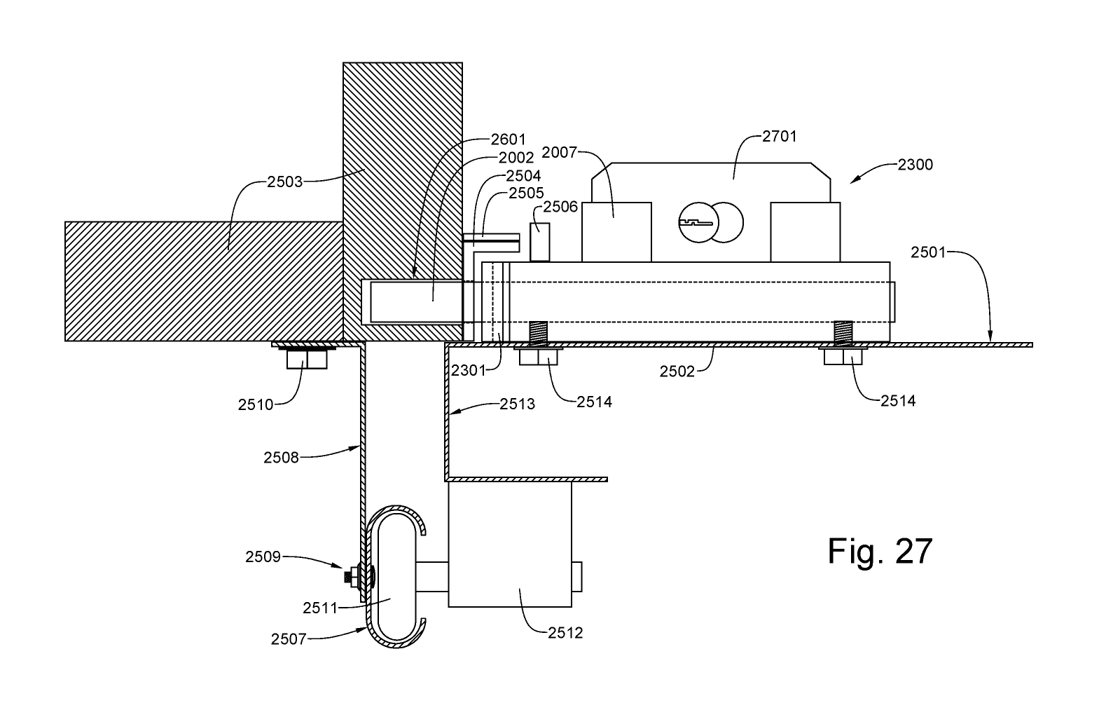

Referring now to FIG. 27, a hidden-shackle lock 2701 from a second manufacturer has been installed within the semi-cylindrical rampart 2007 of the second embodiment locking bolt and housing assembly 2300 of FIG. 26, thereby preventing the bolt 2002 from being withdrawn from the locking aperture 2601.

Referring now to FIG. 28, the third embodiment locking bolt and housing 2400 has been mounted on the exterior surface 2501 of a roll-up door 2502 of the type used on garages, sheds and commercial delivery trucks. An enhanced security strike plate 2801 has been equipped with a U-shaped channel 2802 that surrounds the anti-pry projection 2403 (see FIG. 5). The U-shaped channel 2802 is formed by a right-angle extension 2803 that is unitary with the security strike plate 2801. The anti-pry projection 2403 is trapped within the U-shaped channel 2802 when the roll-up door 2502 is in a fully-down position. A pair of optional silicon or tungsten carbide blocks 2804, brazed to the right-angle extension 903 and a single silicon or tungsten carbide block 905, brazed to the face of the housing 2001, make it difficult for a burglar to cut or grind off right-angle extension 2803 to gain access to the protected locking bolt 2002. The anti-pry feature makes it nearly impossible for a burglar to pry the door to the right in order to extract the bolt 2002 from the bolt aperture 2601, which would enable him to roll up the door and gain access to the protected space. At the very most, a burglar can pry the door 2502 and bolt 2002 to the right only a fraction of a centimeter. Additional silicon or tungsten carbide blocks 2806 can be brazed to the rampart 2007 to hamper cutting or grinding through the rampart and an installed lock. It should be noted that silicon carbide, because it has more than double the hardness of tungsten carbide, is the preferred material for the blocks 2804, 2805 and 2806. Tungsten carbide, though is less expensive.

Though the first embodiment locking bolt and housing assembly 2000 of FIG. 20, the second embodiment locking bolt and housing assembly 2300 of FIG. 23 and the third embodiment locking bolt and housing assembly 2400 of FIG. 24 are all designed to be mounted on the exterior left side of a roll-up door, a mirror image of each embodiment of the locking bolt and housing assembly may also be fabricated for use on the exterior right side of a roll-up door.

Although only seven embodiments of the new locking bolt housing have been shown and described, it will be obvious to those having ordinary skill in the art that changes and modifications may be made thereto without departing from the scope and the spirit of the invention as hereinafter claimed.

What is claimed is:

1. A locking system for installation on parallel-track-mounted, segmented, roll-up doors comprises:
a lockable bolt slidable within a bolt housing mountable on an outer surface and adjacent an edge of the roll-up door;
a striker plate having a bolt aperture and a shield that covers the lockable bolt when the roll-up door is closed and the lockable bolt is inserted within the bolt aperture; and
an anti-pry device, which prevents the roll-up door from being shifted sideways in order to disengage the lockable bolt from the bolt aperture.

2. The locking system of claim 1, wherein for a first primary embodiment of the locking system, said lockable bolt is provided by a conventional deadbolt lock that installs within the bolt housing.

3. The locking system of claim 1, wherein for a second primary embodiment of the locking system:
said lockable bolt is provided with the bolt housing, said lockable bolt sliding within the housing, and having a hasp welded to one end thereof;
over its range of travel, opposite ends of the bolt both remain within apertures in parallel walls of the bolt housing;
the bolt housing incorporates a semi-cylindrical steel rampart on an exterior surface of the housing, which forms a receptacle for a hidden-shackle cylindrical lock, said rampart having a first cutout for the lock's key and a second cutout through which the hasp slides; and
in order to secure the door on which the second embodiment locking system is installed, the locking bolt is slid toward the striker plate so that the end most distant from the hasp exits the housing and enters the bolt aperture within the striker plate, and with the hasp of the locking bolt centered within the lock receptacle, a cylindrical lock is placed within the receptacle and the lock cylinder rotated with a key to secure the cylindrical lock to the hasp, thereby securing the roll-up door.

4. The locking system of claim 1, wherein said anti-pry device comprises:
a first component that mounts on the exterior surface of the roll-up door, adjacent a side edge that is opposite the side on which the deadbolt lock housing is installed; and
a second component that mounts on the door frame opposite and adjacent the first component when the roll-up door is in a down position;
wherein said first and second components, in combination with the lockable bolt housing and strike plate installed on the opposite side of the roll-up door, prevent the roll-up door from being shifted in either direction an amount sufficient to extract the locking bolt from the striker plate.

5. The locking system of claim 4, wherein spacing between said first and second components no more than about 0.25 centimeter when the door is closed.

6. The locking system of claim 1, wherein said anti-pry device comprises:
a vertically-oriented projection strip on an edge of the lockable bolt housing closest to the edge of the door on which it is installed; and
a channel on the striker plate that covers and surrounds the projection on the bolt housing when the roll-up door is fully closed.
